(19) United States
(12) Patent Application Publication
(10) Pub. No.: US 2026/0317084 A1
(43) Pub. Date: Oct. 15, 2026

(54) PICKING AND POSITIONING SYSTEM WITH A SHAPED GRIPPING ELEMENT

(71) Applicant: MARCHESINI GROUP S.P.A., Pianoro (Bologna) (IT)

(72) Inventor: Simone NANNETTI, Pianoro (Bologna) (IT)

(21) Appl. No.: 19/117,133

(22) PCT Filed: Jun. 28, 2023
(86) PCT No.: PCT/IB2023/056673

§ 371 Date: Mar. 31, 2025

(30) Foreign Application Priority Data
Oct. 27, 2022 (IT) 102022000022170

(51) Int. Cl. B65G 47/91; B67C 3/24

(52) U.S. Cl. CPC B65G 47/918; B65G 47/914; B67C 3/24; B65G 2201/0235

(57) ABSTRACT

A picking and positioning system of tubes having a tube axis, for a tube filling plant having a transport system and an operating system is suitable for engaging the tubes in a first position to move and position the tubes in a second position, and has a base group having a base body, extending along a first axis, movable around the first axis, and at least one gripping group, extending along a second axis and having a gripping device having a gripping element engaging a tube, and movable around the second axis. Command devices command the base and gripping groups in movement and command the gripping element and the tube from the first position to the second position. The gripping element is shaped so that, gripped with a tube, the second axis and the tube axis, in relation to an imaginary plane orthogonal to the first axis, are mutually incident.

### DESCRIPTION

The present invention is in relation to a picking and positioning system of tubes for a tube filling plant. Additionally, the present invention is in relation to a tube filling plant that comprises said tubes picking and positioning system.

Known in the state of the art are tube filling plants, that is to say plants that are suitable for executing a series of operations for the production of products in tubular form.

Specifically, embodiments are known wherein the tubes comprise a container made from a plastic material or a metallic material or glassy material or a paper material or else a combination of said materials. Furthermore, embodiments are known wherein the tubes comprise a container made from a solid material or else a soft material. Additionally, embodiments are known wherein the tubes contain a food product, or a cosmetic product or else a pharmaceutical product.

Tube filling plants are suitable for performing specific operations on tubes such as the creation of containers, for example in carrying out bending and/or welding operations but also container filling operations and the like.

Known tube filling plants comprise specific systems wherein each thereof is suitable for carry out appropriate movements and/or operations.

For example, the known tube filling plants comprise transport systems that are suitable for moving tubes. Said transport systems are suitable for performing individualised operations for the moving of tubes in a discreet manner. According to a preferred embodiment, with the transport systems the tubes are arranged in a substantially horizontal position.

Furthermore, the known tube filling plants comprise operating systems that are suitable for carrying out one or more tube operations: for example, cleaning, folding, welding and marking. Preferably, in operating systems the tubes are arranged in a substantially vertical position, in such a manner to be able to carry out one or more of the aforementioned operations, preferably within a region that is proximal to an axial end of the tube. In certain embodiments the operating systems comprise in turn mobile systems that are suitable for moving a tube to distinct operating stations in order to perform distinct operations.

In tube filling plants the passage of the tube from the transport system to the operating system is performed by specific picking and positioning systems that are suitable for gripping the tube from the transport system in order to move it to the operating system.

According to a preferred embodiment, the picking and positioning system grips a tube from a substantially horizontal position in order to position it in a substantially vertical position. According to a further preferred embodiment, the picking and positioning system grips the product from a substantially vertical position in order to position it in a substantially horizontal position. Furthermore, according to other preferred embodiments, the picking and positioning system grips a product from a substantially horizontal position in order to position it in a different substantially vertical position.

Known tube filling plants are studied and utilized for producing thousands of tubes, the number of single operations/movements performed by distinct systems is therefore extremely high.

With particular reference to the picking and positioning system, it is required that the picking and positioning operations be performed with a high level of reproducibility, safety, cleanliness, precision and velocity. At the same time, amongst the most important of requirements, there is the fact that, in order to adapt themselves to the characteristics of the tube, picking and positioning systems should be extremely versatile. Furthermore, it is also requested that the picking and positioning systems have dimensions that are as compact as possible.

In the state of the art, picking and positioning system solutions are known wherein, at best, only one of the aforementioned requests is performed, sacrificing the others. For example, solutions are known for picking and positioning systems with remarkable speed but poor flexibility. Also known are solutions for picking and positioning systems with remarkable flexibility but with a compromised level of safety and cleanliness.

The object of the present invention is that of efficiently resolving the aforesaid situation in proposing a picking and positioning system that may effectively fulfill all of the necessary requirements.

This object is achieved with the picking and positioning system claimed in claim 1. Additionally, the object is achieved with the tube filling plant according to claim 11. The claims dependent on these request protection for further features and entail further technical benefits.

In addition, further features and advantages of the invention will become clear from the description provided below of the preferred embodiments thereof given as non-limiting examples in reference to the attached figures, wherein:

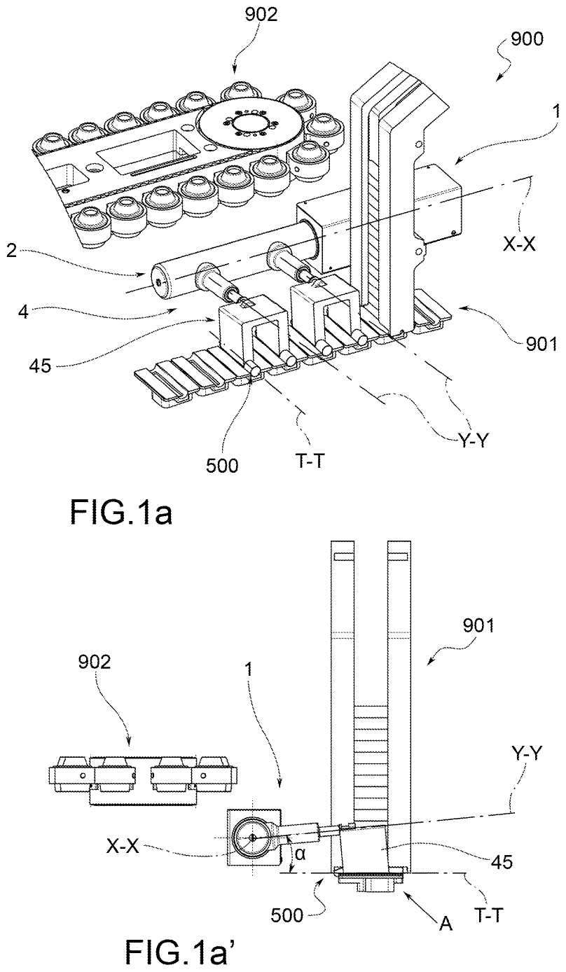

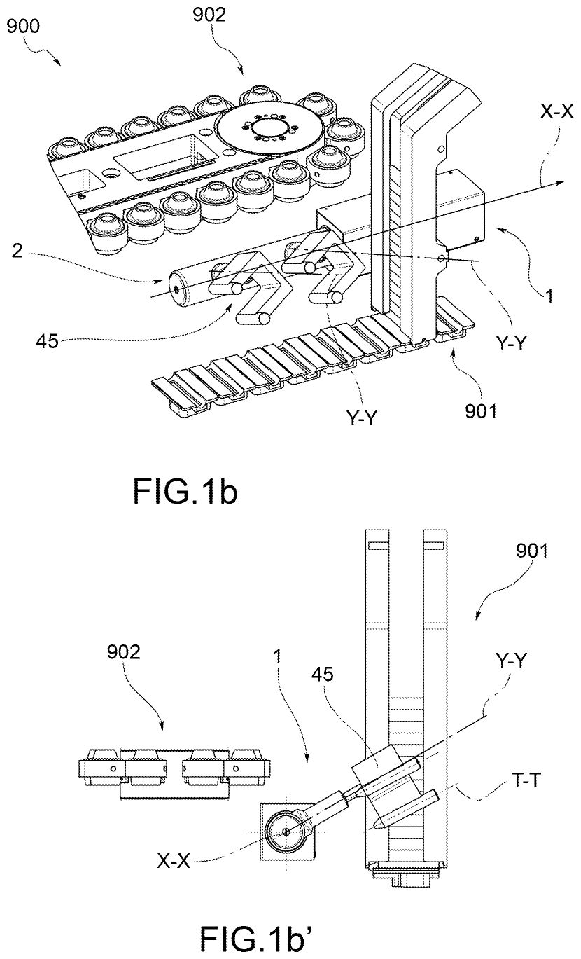

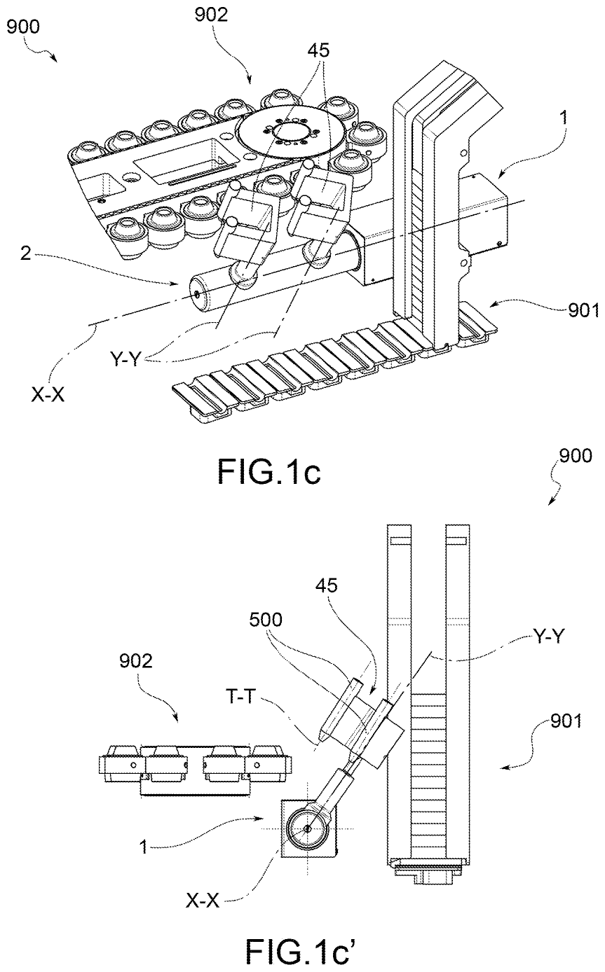

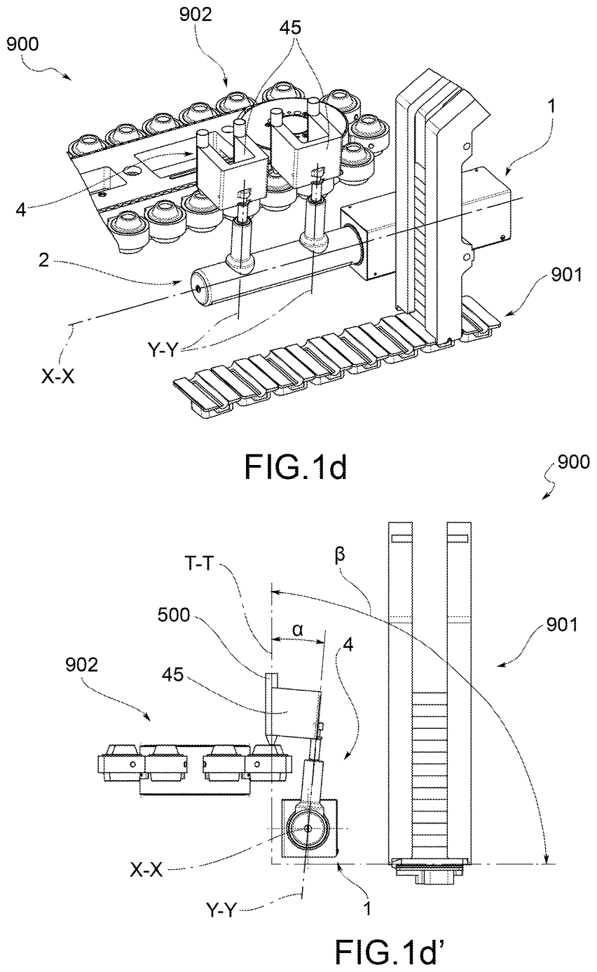

FIGS. 1a, 1b, 1c, and 1d show, in perspective, a tube filling plant in a first position (or picking position), first intermediate position, a second intermediate position and a second £ position (or positioning position or depositing position) according to the present invention, according to a first embodiment;

FIGS 1a′, 1b′, 1c′ and 1d′ show some side views of the tube filling plant in FIGS. 1a, 1b, 1c and 1d;

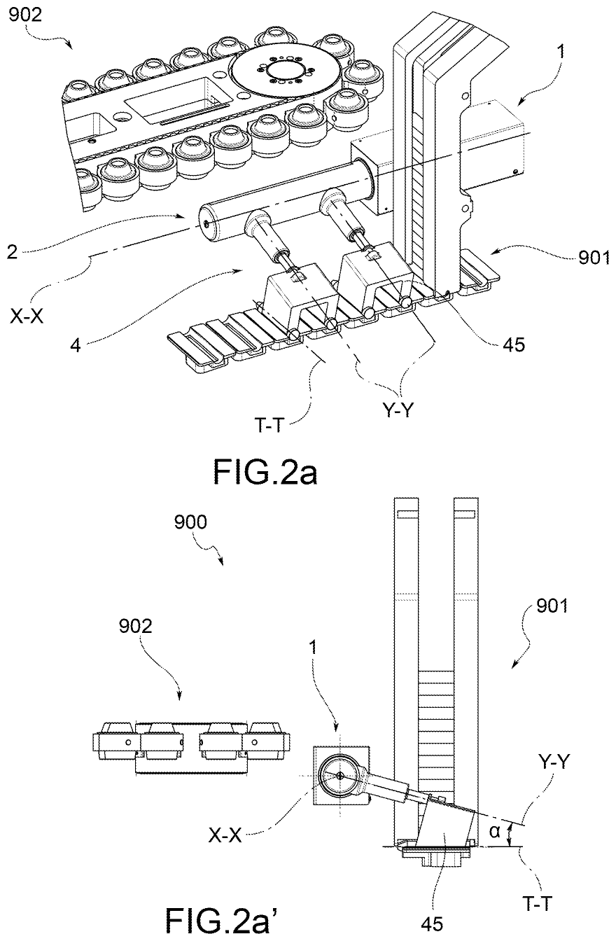

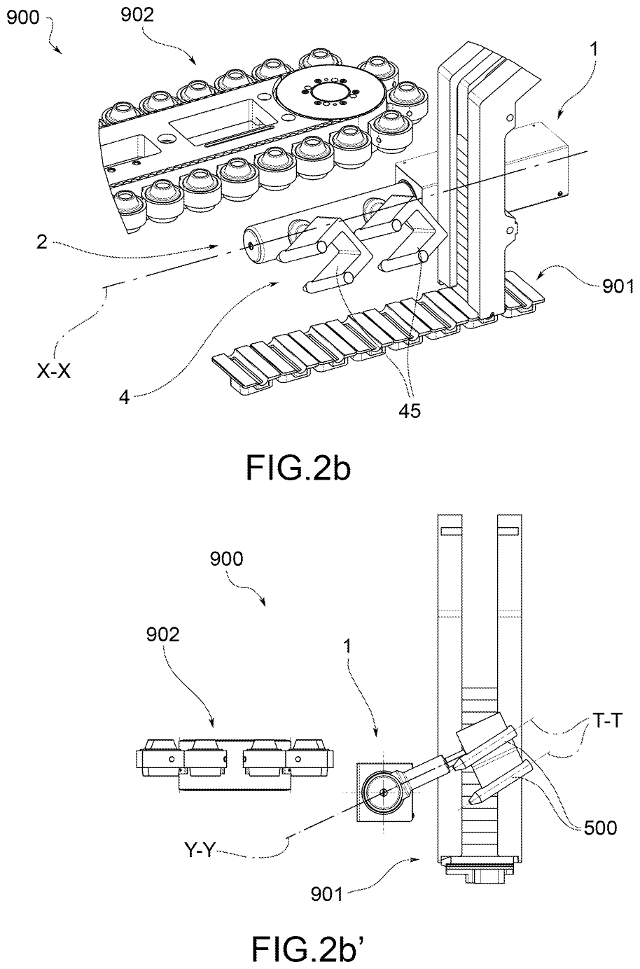

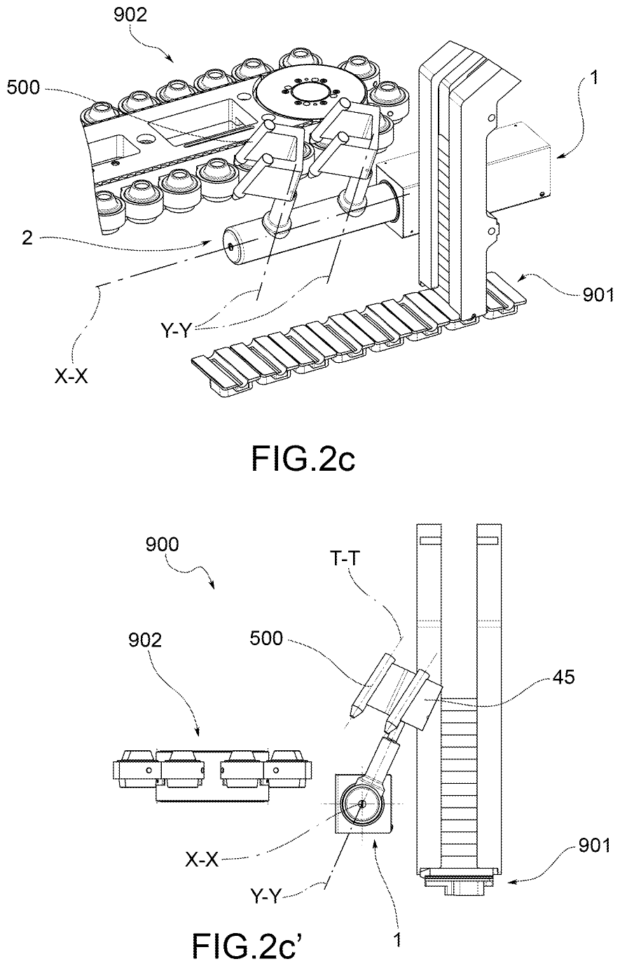

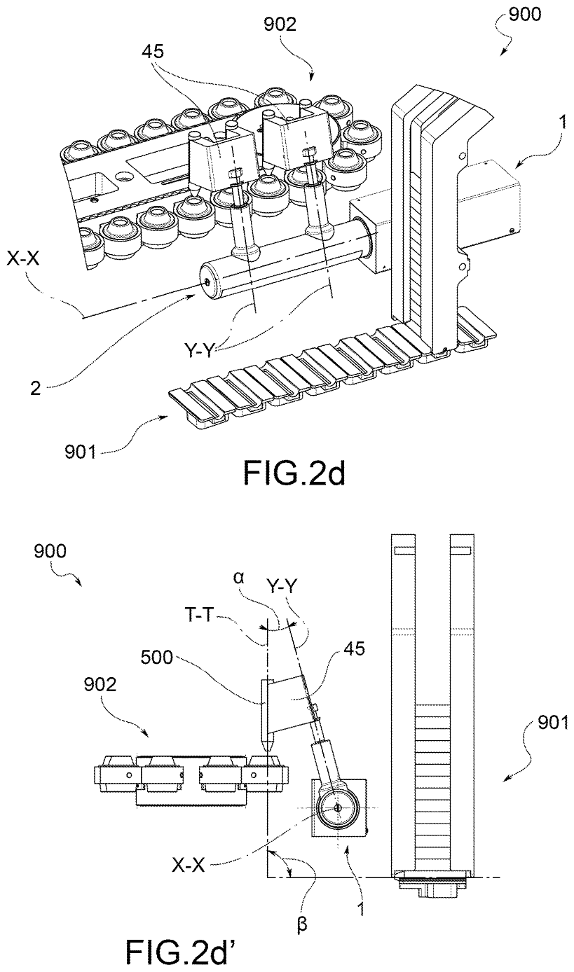

FIGS. 2a, 2b, 2c, and 2d show, in perspective, a tube filling plant in a first position (or picking position), a first intermediate position, a second intermediate position and a second position (or positioning position or depositing position) according to the present invention, according to a second embodiment;

FIG. 2a′, 2b′, 2c′ and 2d′ show some side views of the tube filling plant in FIGS. 2a, 2b, 2c and 2d;

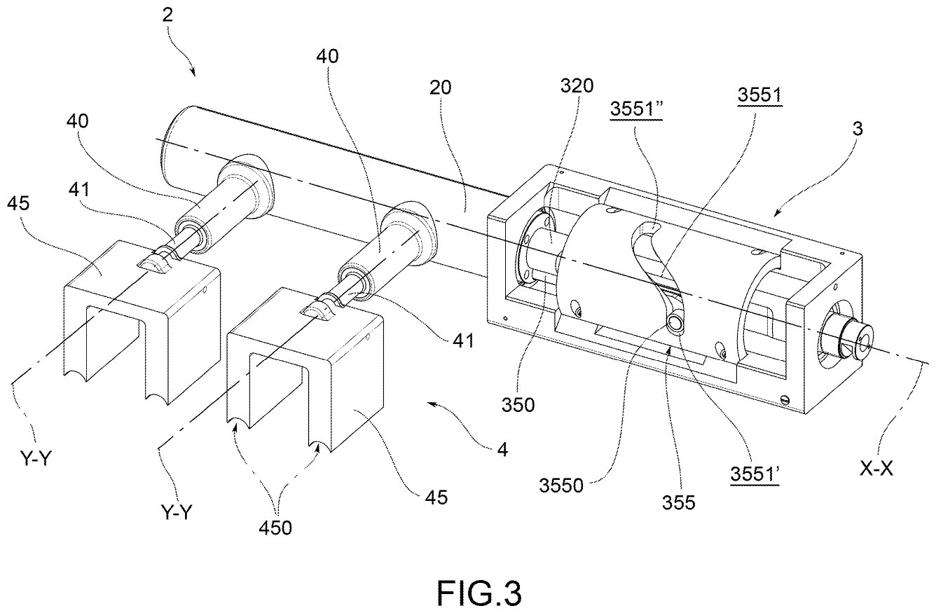

FIG. 3 shows a perspective view of a picking and positioning system, configured in a first position, according to an embodiment, according to the present invention;

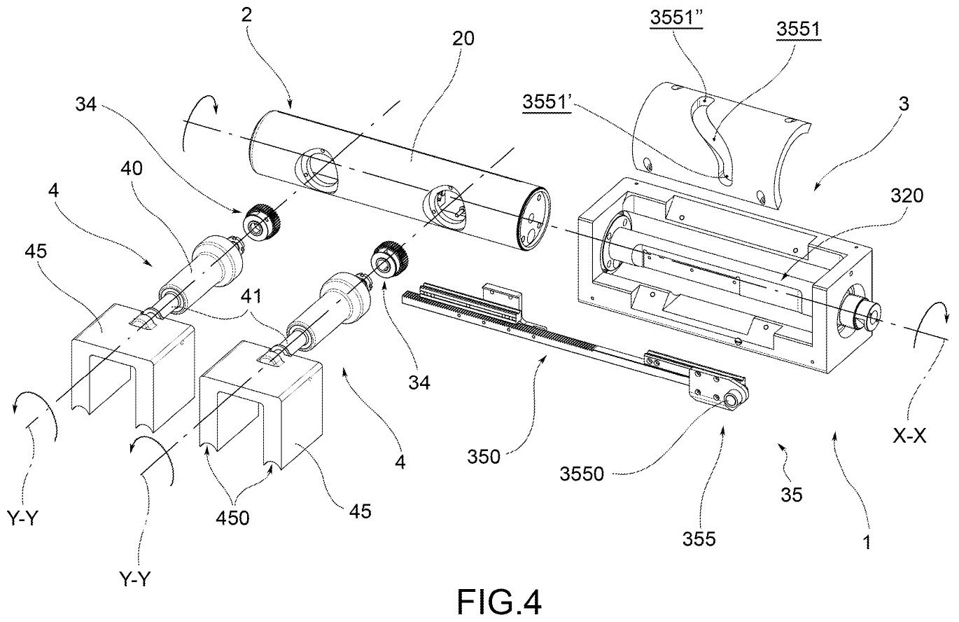

FIG. 4 is a perspective view in separate parts of the picking and positioning system of FIG. 3;

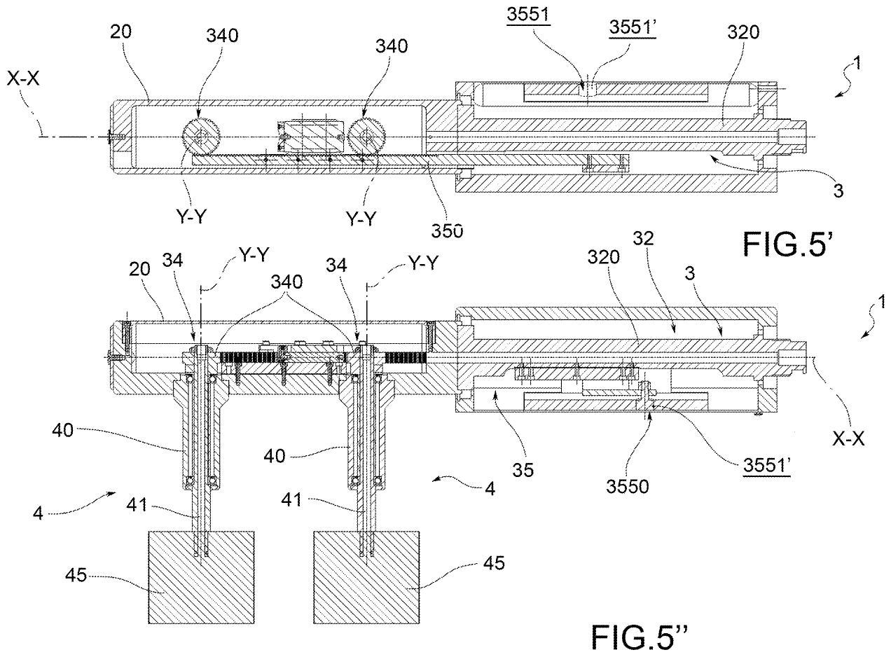

FIG. 5′ and 5″ show the picking and positioning system of FIG. 3 respectively in cross-section along a first axis and along a second axis;

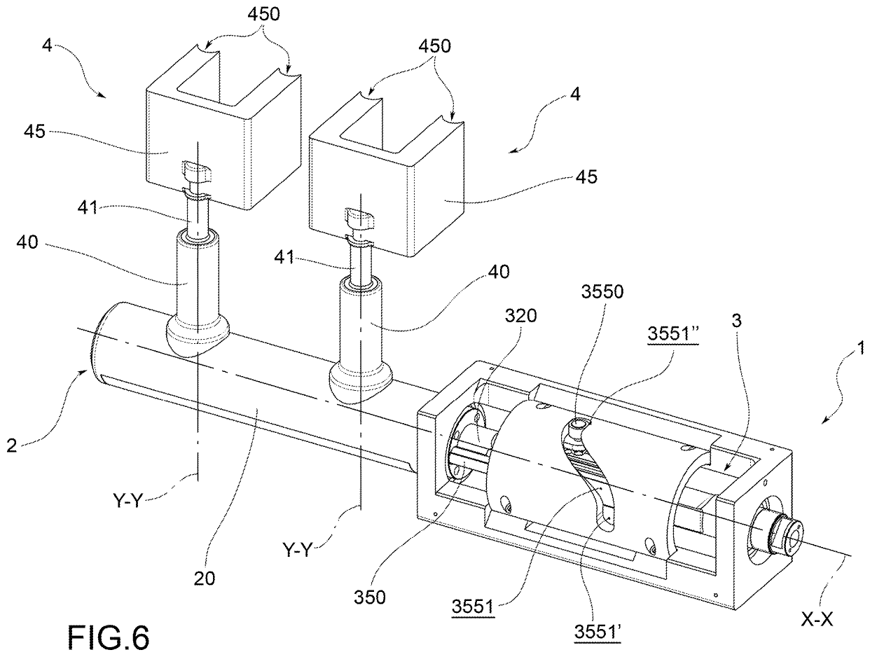

FIG. 6 shows a perspective view of a picking and positioning system, configured in a second position, according to an embodiment, according to the present invention;

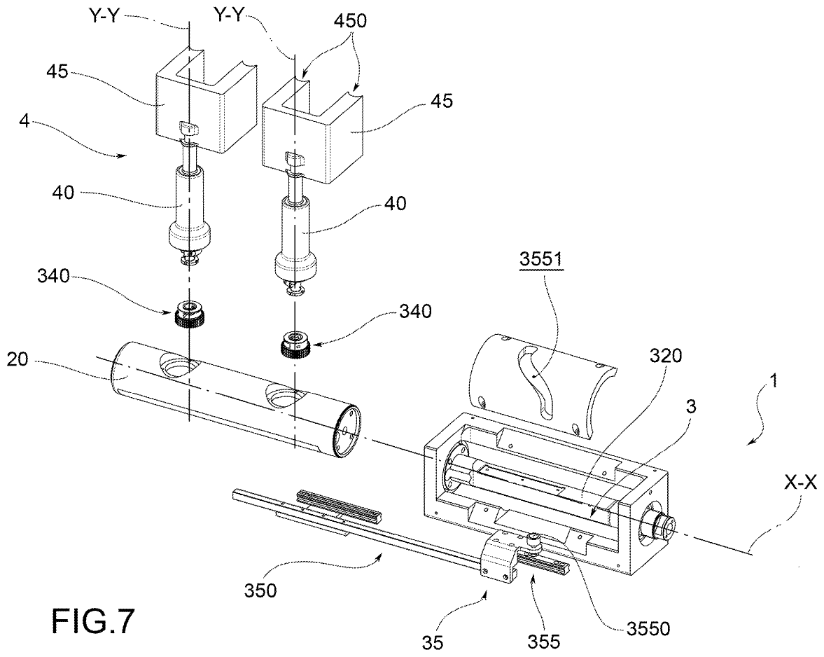

FIG. 7 is a perspective view in separate parts of the picking and positioning system of FIG. 6;

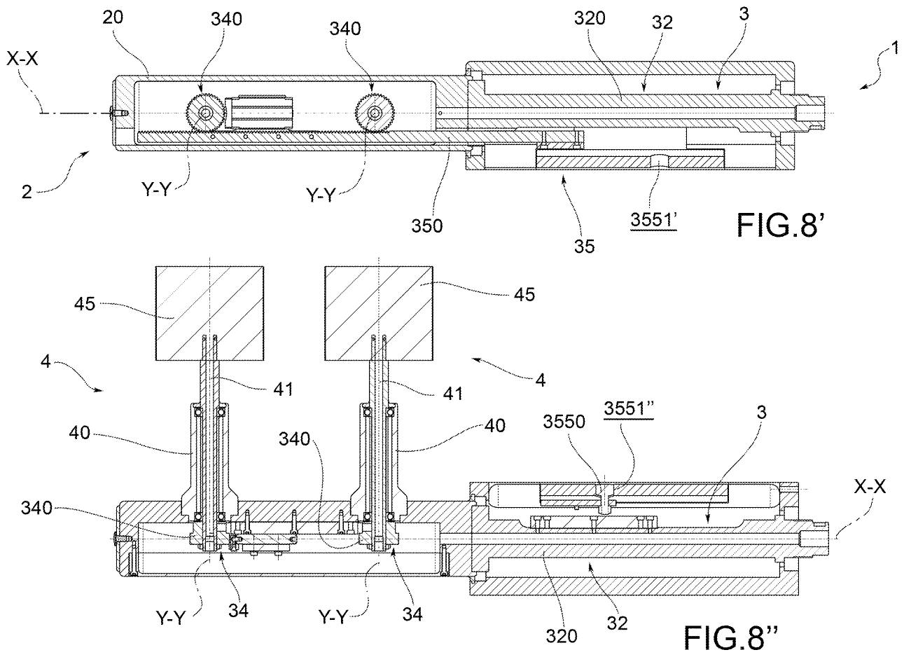

FIG. 8′ and 8″ show the picking and positioning system of FIG. 6 respectively in cross-section along a first axis and along a second axis;

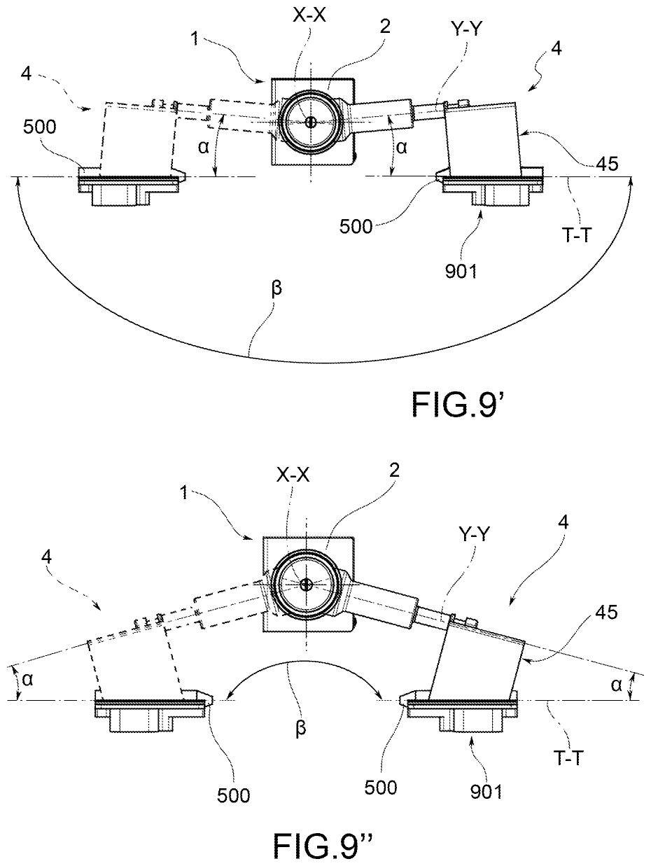

FIG. 9′ and 9″ show, schematically, a plant according to another two preferred embodiments.

With reference to the attached figures, a picking and positioning system 1 of tubes is denoted with the numeral 1. Furthermore, the tube is indicated with the numeral 500. Additionally, the tube filling plant is indicated with the numeral 900.

It should be noted that the form and dimensions of the tube 500 shown in the figures are indicative and are neither representative nor limiting.

According to a preferred embodiment, for each tube 500 a tube axis T-T is identified, in relation whereto it develops longitudinally. According to the present disclosure, the definition of a tube generically refers to products of a substantially cylindrical/elongated form such as tubes but also blister packs and elongated sachets such as stickpacks.

The picking and positioning system 1 is suitable for engaging in grip tubes 500 positioned in a first position A in order to move them and position them in a second position B. Preferably, said first position A corresponds to a picking position. Preferably, said second position B corresponds to the positioning position, or the depositing position.

According to the present invention, tube filling plant 900 of the tubes 500 comprises a transport system 901 of said tubes 500 and an operating system 902 suitable for carrying out specific operations on said tubes 500.

Preferably, the transport system 901 moves the tubes 500, preferably singularly. In other words, the transport system 901 moved the tubes 500 according to a singularization or discretization operation.

According to a preferred embodiment, the transport system 901 comprises a storage or accumulation area wherein a plurality of tubes 500 and a conveyor belt that grips the tubes 500 from the storage area one at a time are housed.

In a preferred embodiment, the tubes 500 are moved by the transport system 901 in a substantially horizontal position in relation to the ground plane.

In other words, the tubes 500 are moved with the tube axis T-T in a substantially horizontal position.

According to a further preferred embodiment, the tubes 500 are moved by the transport system 901 in a substantially vertical position in relation to the ground plane.

In other words, the tubes 500 are moved with the tube axis T-T in a substantially vertical position.

Preferably, the operating system 902 is suitable for carrying out specific operations on the tube 500, for example filling operations and closure/welding/gripping operations, operating at the end of a tube 500.

Preferably, the tube 500 in the operating system 902 is positioned in a substantially vertical position. In other words, the tubes 500 are the object of operations on the part of the operating system 902 with the tube axis T-T in a substantially vertical position. For example, the operating system 902 comprises a pusher group suitable for carrying out a pushing action in a direction parallel or coincident to that of the tube axis T-T.

According to other embodiments, the tube 500 in the operating system 902 is positioned in a substantially horizontal position. In other words, the tubes 500 are the object of operations on the part of the operating system 902 with the product axis T-T in a substantially horizontal position.

According to the present invention, the tube filling plant 900 comprises the picking and positioning system 1 of the tubes 500 which grips a tube 500 from the first position A, wherein the tube 500 is substantially horizontal, and positions it in the second position B, wherein the tube 500 is substantially vertical or vice versa.

According to a preferred embodiment said first position A corresponds to the position of the tubes on the transport system 901. Preferably, in the first position A the tube 500 is in a substantially horizontal position.

According to a preferred embodiment said second position B corresponds to the position of the tubes on the operating system 902. Preferably, in the second position B the tube 500 is in a substantially vertical position.

According to the present invention, the picking and positioning system 1 comprises:
base group 2 comprising a base body 20, which extends along a first axis x-X, wherein said base body 20 is rotatably movable around said first axis X-X;
at least one gripping group 4, engaged to the base body 20, which extends along a second axis Y-Y, incident, preferably orthogonal, to the first axis X-X, comprising a gripping device 45 comprising at least one gripping element 450 which engages the tube 500, wherein said gripping device 45 is rotatably movable around said second axis Y-Y;
command means 3 engaged to the base group 2 and the gripping group 4 to command them in movement and command the gripping element 450, and the tube 500, from the first position A to the second position B.

According to a preferred embodiment, the base body 20 is a hollow element and elongated along the first X-X axis.

According to a preferred embodiment, the gripping group 4 comprises a gripping body 40. Preferably, the gripping body 40 is a hollow element and elongated along the second Y-Y axis. Preferably, the gripping body 40 extends between the base body 20 and the gripping device 45.

Preferably, the gripping body 40 is fastened to the base body 20 and suitable for providing support to the gripping device 45.

Preferably, the gripping device 45 also comprises a shaft 41 which extends, starting from the gripping element 41, along the second axis Y-Y, in part being housed with the gripping body 40.

According to a preferred embodiment, the gripping device 45 comprises two gripping elements 450 suitable for simultaneously engaging two tubes 500. Preferably, the two gripping elements 450 are equidistant from the respective second axis Y-Y.

According to a preferred embodiment variant, the gripping device 45 comprises three gripping elements 450 suitable for simultaneously engaging three tubes 500. Preferably, one gripping element 450 lies along the second axis Y-Y, whilst the other two are equidistant from the respective second axis Y-Y.

According to a preferred embodiment, the picking and positioning system 1 comprises a pneumatic system which is housed, at least partially, in the base body 20 and in the gripping body 40 fluidically connected with the gripping device 45. In other words, the base body 20 and the gripping body 40 extend specific pneumatic ducts. Preferably, the pneumatic system also extends into the shaft 41.

According to a preferred embodiment, the gripping device 45 engages the tube 500 by carrying out a pneumatic suction action.

Preferably, the gripping element 450 has specific openings wherethrough air is sucked. The positioning of the said opening in the wall of a tube therefore allows for gripping, by means of a suction action that is by means of a pneumatic suction action.

Preferably, the gripping element 450 comprises a gripping portion suitable for directly coming into contact with the tube 500. Preferably, said gripping portion is exchangeable as a function of necessity.

According to a preferred embodiment, the picking and positioning system 1 comprises at least two gripping groups 4 axially spaced apart along the X-X axis.

According to a preferred embodiment, the rotation of the gripping group 4 is simultanous with the rotation of the base group 2.

According to a preferred embodiment, the command means 3 comprise:
a first device 32 which moves in rotation the base body 20;
a second device 34 which moves in rotation the gripping group 4, in particular the gripping device 45;
transmission members 35 operatively connected with the first device 32 and with the second device 34 which transform the rotary action of the first device 32 into a rotary action of the second device 34.

Preferably, the first device 32 comprises a command shaft 320 which extends along the first axis X-X. Preferably, the command shaft 320 is engaged with an actuating group, for example, a motor, preferably an electric motor.

According to a preferred embodiment, the transmission members 35 comprise a rack 350 engaged to the first device 32 and to the second device 34.

Preferably, the rack 350 extends parallel to the first axis (X-X).

Preferably, the rack 350 extends parallel to the command shaft 320.

According to a preferred embodiment, the second device 34 comprises a gear 340 engaged to the rack 350.

Preferably, said gear 340 is positioned centered on the second Y-Y axis.

According to a preferred embodiment, said gear 340 engages the shaft 41. With the rotation of the gear 340 there is a corresponding rotation of the shaft 41 and therefore of the gripping device 45.

According to a preferred embodiment, the transmission members 35 furthermore comprise a cam assembly 355 engaged to the rack 350. With the rotation of the first device 32, the cam assembly 355 moves, along the first axis X-X, the gear 350 which rotatably commands the second device 34.

According to a preferred embodiment, the cam assembly 355 comprises a pin 3550 fastened to the rack 350, and to a slot 3551, wherein the rotation of the first device 32 causes the pin 3550 to slide into the slot 3551.

According to a preferred embodiment, the slot 3551 comprises two end regions 3551′, 3551″.

Preferably, the first position A and the second position B of the picking and positioning system 1 correspond to the positioning of the pin 3550 in said end regions 3551′, 3551″, respectively.

According to a preferred embodiment, the rotary movement of the gripping device 45 with respect to the second axis Y-Y is a function of the shape of the slot 3551. As a function of the shape, and of the length of the slot 3551 the movement and the path of the gripping device 45 is in fact controlled. In other words, as a function of the shape and length of the slot 3551 the angle of rotation of the gripping device 45 is controlled with respect to the second axis Y-Y. In other words, as a function of the shape and length of the slot 3551 the rotational speed of the gripping device 45 is controlled with respect to the second axis Y-Y.

According to the present invention, furthermore, the gripping element 450 is shaped in such a manner that gripped with a tube 500, the second axis Y-Y and the tube axis T-T are mutually incident with respect to an imaginary plane orthogonal to the first axis X-X, thus defining a gripping angle α.

According to a preferred embodiment, with the movement from the first position A to the second position B the tube 500 carries out an angular stroke equal to the movement angle β, whilst the base group 2 carries out a rotation around the first axis X-X with an angular stroke equal to the movement angle β less twice the gripping angle α.

Preferably, the base group 2 carries out a rotation around the first axis X-X with a stroke equal to 90° less twice the gripping angle α.

Preferably, the base group 2 carries out a rotation around the first axis X-X with a stroke equal to 180° less twice the gripping angle α.

According to a preferred embodiment, with the movement from the first position A to the second position B the tube 500 carries out an angular stroke equal to the movement angle β, whilst the base group 2 carries out a rotation around the first axis X-X with an angular stroke equal to the movement angle βplus twice the gripping angle a.

According to a preferred embodiment, as a function of the gripping angle a, the movement trajectory of the tube 500 varies.

Preferably, as a function of the type of tube 500 there is a predefined gripping angle a.

According to a preferred embodiment, the engagement of the gripping element 450 to the tube 500 is such as to ensure an elevated contact area thus facilitating the gripping thereof.

According to a preferred embodiment, the picking and positioning system 1 is positioned within the tube filling plant 900 in such a manner to have the first axis X-X at a lower height than the tube 500 positioned in the second position B.

Preferably, the picking and positioning system 1 is positioned within the tube filling plant 900 in such a manner to have the first axis X-X at a height which is equal to or lower than the tube 500 positioned in the first position A.

Preferably, the picking and positioning system 1 is designable in such a manner to have all of the transmission members at a substantially lower position than the tube 500. In particular, the picking and positioning system 1 is presented in such a manner to be positioned lower than the upper end, preferably open, of the tube 500.

According to a preferred embodiment, the gripping angle a affects the movement stroke of the tube 500.

Innovatively, the picking and positioning system fully fulfills the intended purpose in overcoming the typical problems of the prior art.

Advantageously, in fact, the picking and positioning system makes it possible to achieve all of the requirements of the sector.

Advantageously, the picking and positioning system carries out identically reproducible movements over time.

Advantageously, the picking and positioning system carries out movements with elevated precision thus always ensuring precise positioning both in the first position and the second position.

Advantageously, the picking and positioning system carries out movements ensuring an elevated level of cleanliness and safety. Advantageously, the picking and positioning system finds application in the pharmaceutical, ensuring an elevated level of tube cleanliness.

Advantageously, the picking and positioning system results in being extremely flexible: it is in fact extremely simple to adapt the picking and positioning system, and in particular the movements thereof as a function of various tube topologies.

Advantageously, in designing and appropriately choosing the slot, and in particular the shape and dimensions thereof, the tube movement trajectory is modifiable.

Advantageously, in designing and appropriately choosing the gripping angle the tube movement trajectory is modifiable.

Advantageously, the picking and positioning system is suitable for occupying minimal space within the tube filling plant. Advantageously, the picking and positioning system is positionable, without any particular problems, either partially or completely, in a position covered by the transport system and/or by the operating system.

Advantageously, the picking and positioning system is positionable, without any particular problems, within a region with less space in relation to the other systems of the tube filling plant or within a region with more space in relation to the other systems of the tube filling plant.

Advantageously, the transport system and the operating system are positionable mutually proximal therebetween or else mutually distal therebetween, designing for the best the picking and positioning system, for example in choosing the form of the gripping device.

Advantageously, the tube filling plant is designable as a function of requirements in taking advantage of the design versatility of the picking and positioning system.

Advantageously, the picking and positioning system is suitable for operating with tubes of varying lengths. Advantageously the height of a tube is not a limit for the picking and positioning system.

It is clear that a person skilled in the art may make changes to the invention described above in order to meet contingent needs, which changes all fall within the scope of protection as defined in the following claims.

1. A picking and positioning system of tubes having a tube axis, for a tube filling plant, comprising a transport system and an operating system, wherein the picking and positioning system is suitable for engaging in grip the tubes positioned in a first position to move and position them the tubes in a second position, wherein the picking and positioning system comprises:
a base group comprising a base body which extends along a first axis (X-wherein the base body is rotatably movable around said the first axis
at least one gripping group, engaged to the base body, which extends along a second axis incident, to the first axis, comprising a gripping device comprising at least one gripping element which engages a tube, wherein the gripping device is rotatably movable around the second axis and
command means engaged to the base group and the at least one gripping group to command them the base group and the at least one gripping group in movement and command the at least one gripping element and the tube, from the first position to the second position; and
wherein the at least one gripping element is shaped in such a manner that gripped with the tube, the second axis and the tube axis are mutually incident with respect to an imaginary plane orthogonal to the first axis, thus defining a gripping angle.

2. The picking and positioning system of claim 1, wherein, in a movement from the first position to the second position, the tube carries out a movement equal to a movement angle, while the base group carries out a rotation around the first axis with an angular stroke equal to the movement angle less twice the gripping angle or with an angular stroke equal to the movement angle plus twice the gripping angle.

3. The picking and positioning system of claim 1, wherein the gripping device comprises two gripping elements suitable for simultaneously engaging two tubes.

4. The picking and positioning system according to any of claim 1, wherein the gripping device engages the tube (500) by carrying out a pneumatic suction action.

5. The picking and positioning system of claim 1, comprising at least two gripping groups axially spaced apart along the first axis (X).

6. The picking and positioning system of claim 1, wherein the at least one gripping group comprises a gripping body which extends along the second axis between the base body and the gripping device.

7. The picking and positioning system according to of claim 6, wherein the gripping device engages the tube by carrying out a pneumatic suction action, and wherein the picking and positioning system further comprises a pneumatic system which is housed in the base body and in the gripping body fluidically connected with the gripping device.

8. The picking and positioning system of claim 1, wherein the command means comprise:
a first device which moves in rotation the base body;
a second device which moves in rotation the at least one gripping group; and
transmission members operatively connected with the first device and with the second device which transform a rotary action of the first device into a rotary action of the second device

9. The picking and positioning system of claim 8, wherein the transmission members comprise a rack engaged to the first device and to the second device, and a cam assembly engaged to the rack, wherein with a rotation of the first device, the cam assembly moves along the first axis the rack, which rotatably commands the second device.

10. The picking and positioning system of claim 9, wherein the cam assembly comprises a pin fastened to the rack, and a slot, and wherein the rotation of the first device causes the pin to slide into the slot.

11. The picking and positioning system of claim 10, wherein the slot comprises two end regions, and wherein the first position and the second position of the picking and positioning system correspond to a positioning of the pin in said end regions, respectively.

12. A tube filling plant, comprising a transport system of tubes an operating system suitable for carrying out specific operations on the tubes, wherein the tube filling plant comprises the picking and positioning system of claim 1, and wherein the first position is on the transport system and the second position is on the operating system.

13. The tube filling plant of claim 12, wherein the picking and positioning system picks up a tube from the first position, in which the tube is substantially horizontal, and positions the tube in the second position, in which the tube is substantially vertical, or vice versa.

14. The tube filling plant of claim 12, wherein the picking and positioning system is positioned in such a manner to have the first axis at a lower height than the tube positioned in the second position.

15. The tube filling plant of claim 14, wherein the picking and positioning system is positioned in such a manner to have the first axis at a height equal to or lower than the tube positioned in the first position.

16. The picking and positioning system of claim 1, wherein the first position is on the transport system.

17. The picking and positioning system of claim 1, wherein the second position is on the operating system.

18. The picking and positioning system of claim 1, wherein the second axis is orthogonal to the first axis.

19. The picking and positioning system of claim 8, wherein the second device moves in rotation the gripping device.

20. The tube filling plant of claim 12, wherein the transport system moves the tubes singularly.
